(19) United States
(12) Patent Application Publication
(10) Pub. No.: US 2017/0113608 A1
(43) Pub. Date: Apr. 27, 2017

(54) SYSTEM AND METHOD FOR OPERATING A MACHINE

(71) Applicant: Caterpillar Inc., Peoria, IL (US)

(72) Inventors: Khyati T. Patel, Aurora, IL (US); Michael E. Hague, Washington, IL (US)

(73) Assignee: Caterpillar Inc., Peoria, IL (US)

(21) Appl. No.: 14/923,471

(22) Filed: Oct. 27, 2015

(51) Int. Cl. B60Q 9/00; G08G 1/16

(52) U.S. Cl. CPC B60Q 9/008; G08G 1/16

(57) ABSTRACT

A method of operating a machine is provided. The method includes determining a required stopping distance, a loading condition and a current speed of the machine. The method also includes generating a warning signal to warn an operator of the machine based on the required stopping distance, the loading condition and the current speed.

### TECHNICAL FIELD

The present disclosure relates to a system and method for operating a machine, and more particularly to a system and method for warning an operator of the machine about possible collision with an object in a travel path of the machine.

### BACKGROUND

A machine, such as a dump truck, may move along a travel path to perform one or more operations. An operator of the machine may need to know whether any object is present along the travel path of the machine so that the operator could take measures to halt the machine within a stopping distance. If the operator is not alerted about such a situation, the machine may collide with the object, which is not desirable. Some machines include maps that identify the object and warn the operator in advance so that the operator may take necessary action to stop the machine within its stopping distance. However, the stopping distance of the machine is different when the machine is in a loaded condition as compared to a situation when the machine is in an unloaded condition. Therefore, the maps configured for the loaded condition of the machine may not be completely reliable to be used in the situation when the machine is in the unloaded condition, and vice-versa. Thus, the existing machines may not have means to accurately calculate the stopping distance and therefore, may not reliably alert the operator about the possibility of a collision with an object in a travel path of the machine. This poses a serious threat to the safety of the operator and the machine.

U.S. Pat. No. 6,708,100 describes an adaptive cruise control system which includes a radio frequency (RF) transmit receive (TR) sensor module (or more simply “sensor”) disposed such that a detection zone is deployed in front of a vehicle. The sensor includes a sensor antenna system which comprises a transmit antenna for emitting or transmitting an RF signal and a receive antenna for receiving portions of the transmitted RF signal which are intercepted by one or more objects within a field of view of the transmit antenna and reflected back toward the receive antenna. With this particular arrangement, a detection system that detects objects in a region about a front of a vehicle is provided. If the system determines that the vehicle is approaching an object or that an object is approaching the vehicle, then the sensor initiates steps that are carried out in accordance with a set of rules that control an accelerator of the vehicle. The accelerator is adjusted to maintain a safe trailing distance behind the detected object. In one example, it is described that the system further takes into consideration the loading condition of the machine. However the system is not capable to alert the operator about possible collision.

### SUMMARY OF THE DISCLOSURE

In one aspect of the present disclosure, a method of operating the machine is described. The method includes determining a required stopping distance of the machine. The method also includes sensing a loading condition of the machine. The method further includes sensing a current speed of the machine. The method also includes generating a warning signal to warn an operator of the machine based on the required stopping distance, the loading condition and the current speed.

In another aspect of the present disclosure, a control system for operating a machine is described. The control system includes an object detection unit configured to detect an object in a travel path of the machine and determine a distance between the machine and the object. The control system also includes a payload sensing unit configured to sense a loading condition of the machine. The control system further includes a speed sensing unit configured to sense a current speed of the machine. The control system also includes a controller. The controller is configured to determine a required stopping distance for the machine based on the distance between the machine and the object. The controller is further configured to generate a warning signal to warn an operator of the machine based on the stopping distance, the loading condition and the current speed.

In yet another aspect of the present disclosure, a machine is described. The machine includes a power source configured to move the machine. The machine also includes a loading structure configured to hold a payload in the machine. A control system is provided for operating the machine. The control system includes an object detection unit configured to detect an object in a travel path of the machine and determine a distance between the machine and the object. The control system also includes a payload sensing unit configured to sense a loading condition of the machine. The control system further includes a speed sensing unit configured to sense a current speed of the machine. The control system also includes a controller. The controller is configured to determine a required stopping distance for the machine based on the distance between the machine and the object. The controller is further configured to generate a warning signal to warn an operator of the machine based on the stopping distance, the loading condition and the current speed.

Other features and aspects of this disclosure will be apparent from the following description and the accompanying drawings.

### BRIEF DESCRIPTION OF THE DRAWINGS

FIG. 1 is a side view of an exemplary machine movable along a travel path, according to an embodiment of the present disclosure;

FIG. 2 is a schematic block diagram of a control system associated with the machine, according to an embodiment of the present disclosure;

FIG. 3 is an exemplary representation of lookup maps associated with the control system, according to an embodiment of the present disclosure; and

FIG. 4 is a flowchart representing a method of operating the machine, according to an embodiment of the present disclosure.

### DETAILED DESCRIPTION

Reference will now be made in detail to specific aspects or features, examples of which are illustrated in the accompanying drawings. Wherever possible, corresponding or similar reference numbers will be used throughout the drawings to refer to the same or corresponding parts.

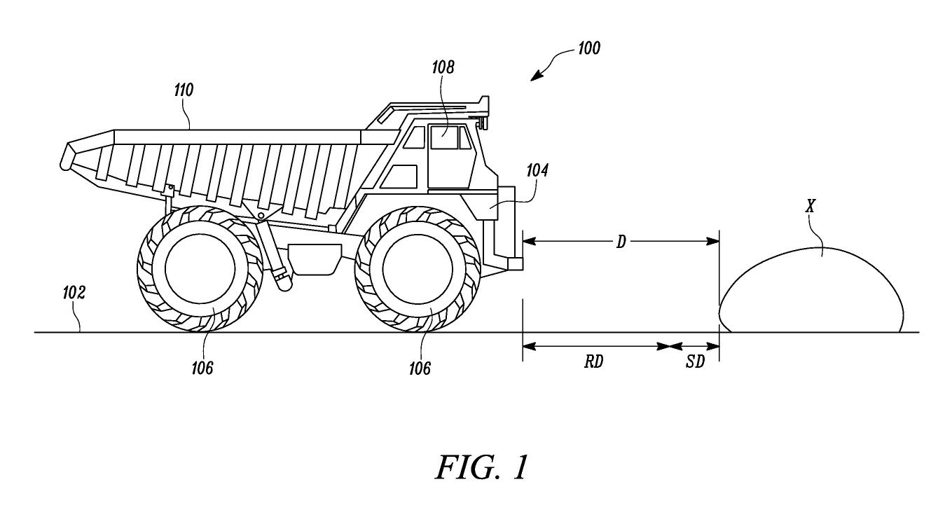

Referring to FIG. 1, an exemplary machine 100 is illustrated. As shown, the machine 100 embodies a work machine used in various applications to move a payload. The machine 100 may be configured to perform operations associated with industries such as mining, construction, farming, etc. and operates in work environments like construction site, mining site, power plants, etc. In an exemplary embodiment, as illustrated in FIG. 1, the machine 100 is a dump truck. Although the dump truck is illustrated as an off highway truck, those skilled in the art will appreciate that the present invention is applicable to virtually all dump trucks, such as mining trucks, articulated trucks or the like. Alternatively, the machine 100 may be any machine including, but not limited to, a wheel loader, an excavator, a shovel, a dozer, a track type tractor, a forklift, a crane, or any machine known in the art associated with, but not limited to, material handling applications.

The machine 100 is movable along a travel path 102 in an intended direction. As illustrated in FIG. 1, the machine 100 includes a frame 104. The machine 100 also includes a power source (not shown) configured to provide power to the machine 100 for operational and mobility requirements. The power source may be an internal combustion engine, an electric motor, power storage device like batteries, a hybrid engine or any power source known in the art. The machine 100 further includes a set of ground engaging members 106 such as wheels or track. The ground engaging members 106 are configured to provide mobility to the machine 100. The machine 100 may also include a drivetrain (not shown) coupled to the power source and the ground engaging members 106. The drivetrain may include a transmission system having one or more gears, shafts, torque convertor, hydraulic pump or motor, and so on. The drivetrain may be configured to transmit motive power from the power source to the ground engaging members 106. The machine 100 also includes a braking system (not shown) configured to engage with the ground engaging members 106 and/or the transmission system to slow or stop the machine 100 while moving along the travel path 102.

The machine 100 may also include an operator cabin 108 provided on the frame 104. The operator cabin 108 may provide an operator interface (not shown). The operator interface may include one or more input devices like braking pedal, steering, joystick, knobs, levers, switches, display devices and so on. The input device may be configured for operating and controlling one or more parameters of the machine 100. The operator interface may also include one or more output devices like a display screen, a warning light, a haptic feedback arrangement, etc.

The machine 100 includes a loading structure 110 supported on the frame 104. In the present example, the loading structure 110 is in the form of a dump body pivotally connected to the frame 104 of the machine 100. Alternately, in case the machine 100 is a wheel loader or the like, the loading structure 110 may be in the form of a bucket or the like, pivotally connected to the frame 104. It should be noted that the loading structure 110 may not necessarily be pivotally connected and further be of any form as per machine requirements. The loading structure 110 is configured to hold a payload in the machine 100. The loading structure 110 may be supported with respect to the frame 104 by shock-absorbing or cushioning elements made of rubber-like material and arranged at spaced intervals throughout the frame 104 and longitudinally extending reinforcing members beneath a bottom of the frame 104, in the machine 100.

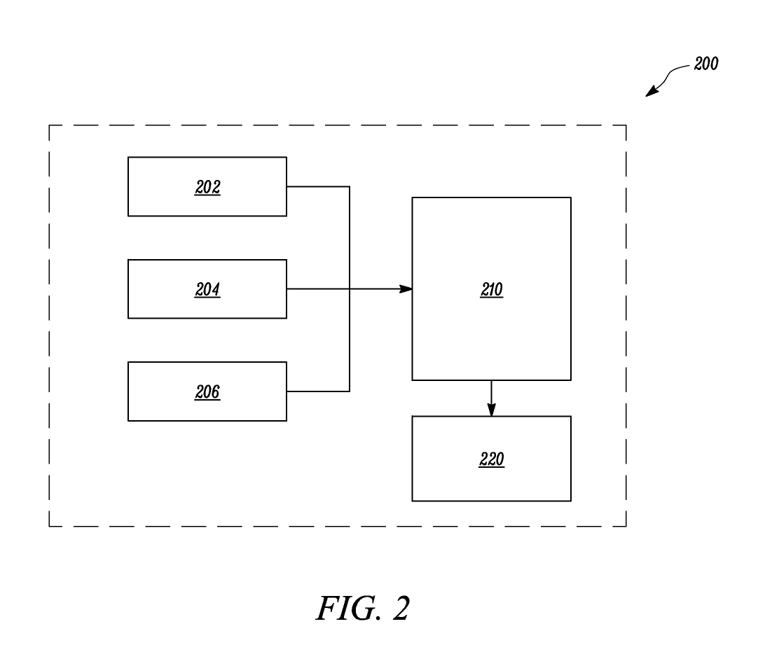

In an embodiment, the machine 100 includes a control system 200, schematically represented and described in detail with reference to FIG. 2. The control system 200 may be an arrangement of assemblies, sensors and control devices working in combination to operate the machine 100. The control system 200 is configured to detect an object ‘X’, as illustrated in FIG. 1, and warn the operator of the machine 100 in due time to prevent collision with the object ‘X’, as the machine 100 moves on the travel path 102. The object ‘X’ may be any of a stationary obstacle and a moving vehicle present on the travel path 102 of the machine 100. In the present disclosure, the control system 200 is configured to consider a loading condition of the machine 100, where the loading condition is based on a weight of the payload in the loading structure 110, to warn the operator of the machine 100.

For this purpose, the control system 200 includes an object detection unit 202. The object detection unit 202 may be configured to detect the object ‘X’ in the travel path 102 of the machine 100. The object detection unit 202 may include one or a combination of a RADAR, a LIDAR, an image capturing device, a proximity sensor, an ultrasonic sensor, an infrared sensor, and the like in order to detect the presence of the object ‘X’ along the travel path 102. In one example, the object detection unit 202 may also include a motion sensor that detects a movement of a human, an animal or a driven vehicle along the travel path 102. Further, the object detection unit 202 is configured to determine a distance ‘D’ between the machine 100 and the object ‘X’. It may be contemplated by a person skilled in the art that the object detection unit 202 may be configured to use a combination of formulas and empirical data from the various sensors to calculate the distance ‘D’ between the machine 100 and the object ‘X’.

The control system 200 also includes a payload sensing unit 204. The payload sensing unit 204 may include at least one weight sensor (not shown) associated with the loading structure 110, in the machine 100. Specifically, the weight sensor may be associated with the pivoting arrangement of the loading structure 110. In one example, the weight sensor may be a strain gauge. Those skilled in the art will appreciate that other types of weight sensors may be substituted, such as a load cell, without departing from the scope of the present disclosure. Alternately, the payload sensing unit 204 may include one or more pressure sensors associated with suspension struts of the loading structure 110 to measure pressure therein. The payload sensing unit 204 may be configured to use a combination of formulas and empirical data to calculate the weight of the payload using the pressure measurement. In one example, the payload sensing unit 204 may further be configured to take into consideration weight of any other elements that may be present in the machine 100. By measuring/calculating the weight of the payload, the payload sensing unit 204 may be configured to sense a loading condition of the machine 100.

Further, the control system 200 includes a speed sensing unit 206. The speed sensing unit 206 is configured to sense a current speed of the machine 100. The speed sensing unit 206, generally, includes one or more sensors disposed in association with the ground engaging members 106 and/or the transmission system of the machine 100. The methods employed by speed sensing units are well known in the art and have not been described in detail for the brevity of the disclosure.

In an embodiment, the control system 200 further includes a controller 210. It may be understood that the controller 210 may be a logic unit using any one or more of a processor, a microprocessor, a microcontroller, or any other suitable means. The controller 210 may be based on integrated circuitry, discrete components, or a combination of the two. It will be appreciated that other peripheral circuitry such as buffers, latches, switches and so on may be implemented within the controller 210 or separately as desired. The controller 210 may be configured to receive communication from the object detection unit 202, the payload sensing unit 204 and the speed sensing unit 206 in a conventional manner. For example, the controller 210 may have communication lines disposed in connection with the object detection unit 202, the payload sensing unit 204 and the speed sensing unit 206.

In an embodiment, the controller 210 may be configured to determine a required stopping distance ‘RD’ for the machine 100 based on the distance ‘D’ between the machine 100 and the object ‘X’. The required stopping distance ‘RD’ may be calculated by taking into consideration a safety margin distance ‘SD’ from the object ‘X’. Specifically, the controller 210 is configured to determine the required stopping distance ‘RD’ by subtracting the safety margin distance ‘SD’ from the distance ‘D’. It may be understood that the safety margin distance ‘SD’ is defined as a minimum distance to be maintained between the machine 100 and the object ‘X’, as the machine 100 is stopped in front of the object ‘X’, to safely avoid the collision between the machine 100 and the object ‘X’. Further, in an embodiment, the controller 210 may be configured to factor in an operator reaction time while determining the required stopping distance ‘RD’ for the machine 100.

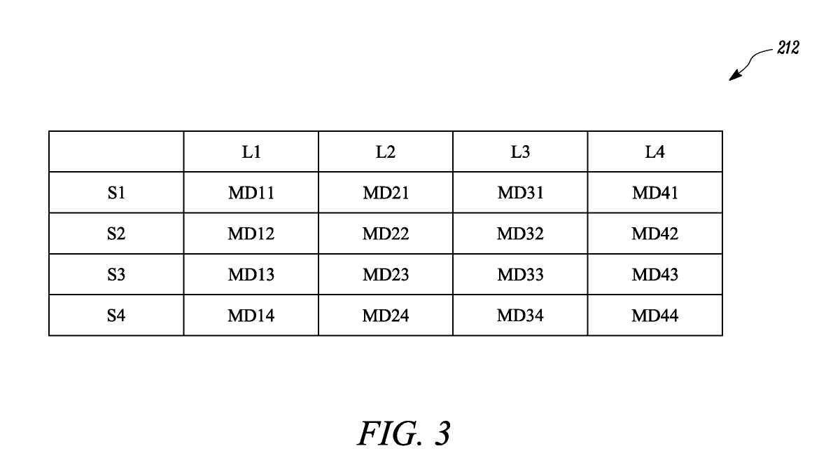

In an embodiment, the controller 210 may include pre-defined lookup maps 212, as illustrated in FIG. 3. The lookup maps 212 may be stored in a memory (not shown) of the controller 210. FIG. 3 illustrates an exemplary lookup map 212, according to an embodiment of the present disclosure. The lookup map 212 may include one or more sets of two-dimensional arrays to store the values for machine stopping distances, generally represented as ‘MD’, corresponding to the combinations of the various values of the loading conditions, generally represented as ‘L’, and the current speeds, generally represented as ‘S’, of the machine 100. In an alternate embodiment, the loading conditions ‘L’ and the current speeds ‘S’ may be represented in the form of a curve, where the machine stopping distances ‘MD’ may be determined based on a function of the curve using some empirical formulas.

FIG. 3 illustrates the lookup map 212 with only one set of two-dimensional array for simplification. As illustrated, the lookup map 212 store the values for a machine stopping distance MD11, MD12, . . . , MD21, MD22, . . . corresponding to the pre-determined combinations of the loading conditions L1, L2, . . . and the current speeds S1, S2, . . . stored in the memory. It may be contemplated that the lookup map 212 may include multiple sets of two-dimensional arrays, and further the controller 210 may include multiple lookup maps 212 for faster processing and memory management purposes as would be understood by a person skilled in the art of database management. Alternatively, the controller 210 may utilize a conventional proportional derivative algorithm to dynamically generate the values for machine stopping distance ‘MD’ based on the loading condition ‘L’ and the current speed ‘S’, of the machine 100.

In an embodiment, the controller 210 is further configured to generate a warning signal to warn an operator of the machine 100 based on the required stopping distance ‘RD’, the loading condition ‘L’ and the current speed ‘S’. Specifically, the controller 210 is configured to generate the warning signal when the required stopping distance ‘RD’, corresponding to the loading condition ‘L’ and the current speed ‘S’ of the machine 100, is substantially equal to or slightly greater than the corresponding value of the machine stopping distance ‘MD’ for the equivalent values of the loading condition ‘L’ and the current speed ‘S’ in the lookup maps 212.

In an embodiment, the control system 200 further includes an alarm device 220. The alarm device 220 may form a part of the operator interface as described above. The alarm device 220 is communicably coupled to the controller 210 in a wired or wireless manner. The alarm device 220 may be configured to generate a warning alert for the operator based on the receipt of the warning signal from the controller 210. The warning alert may notify the operator regarding the possible collision with the object ‘X’ present along the travel path 102 of the machine 100. The warning alert may be in audio, visual, haptic or any other suitable form capable of being perceived by the operator. For example, the warning alert may be any one or a combination of an audible beep, a light flash, a tactile feedback of an operator seat or the input device, a text notification on the operator interface, etc.

In one example, the alarm device 220 may be present within the operator cabin 108 of the machine 100. It should be noted that the alarm device 220 may be positioned at any location within the operator cabin 108 such that the operator is able to perceive the warning alert. In other example, the alarm device 220 may be positioned remotely from the operator cabin 108 of the machine 100. For example, the alarm device 220 may be mounted on the machine 100, but at a location that is exterior to the operator cabin 108 of the machine 100, such as a roof of the operator cabin 108. This configuration may be particularly helpful in case when the object ‘X’ is a driven vehicle. In such an example, the alarm device 220 may be capable of providing the warning alert to the operator seated within the machine 100 as well as to the driver of the driven vehicle. Further, in a situation where the machine 100 is a semi-autonomous or a fully autonomous machine, the alarm device 220 may be remotely positioned from the machine 100. For example, the alarm device 220 may be mounted at the remote station, so that the operator seated at the remote station is provided with the warning alert about possible collision with the object ‘X’ present along the travel path 102 of the machine 100.

### INDUSTRIAL APPLICABILITY

It is known that the stopping distance of a machine varies with a loading condition of the machine. When the machine is in a loaded condition, the machine generally has a larger stopping distance compared to a situation when the machine is in an unloaded condition, for a same braking effort and other conditions being kept constant. Therefore, as a weight of a payload increases in the machine, typically the stopping distance of the machine also increases. Some of the existing machines, primarily passenger vehicles, include systems to warn a driver of a possible collision with an object in a travel path of the machine. However, such machines do not take into consideration the loading condition of the machine. Therefore, the existing systems designed primarily for an unloaded condition of the machine may not be reliable in a loaded condition of the machine, and vice versa. Even systems designed for average loading condition of the machine may not be considered completely reliable for operating a machine required to operate in different loading conditions. For example, it may be contemplated that a machine having a system designed to work primarily in range of the unloaded condition may lead to a delay in generating an alert to warn the driver of the possible collision when the machine is operating in the loaded condition. This may seriously impact the safety of the driver in the machine.

The control system 200 of the present disclosure is operable in varying loading condition ‘L’ of the machine 100. The control system 100 takes into consideration the loading condition ‘L’ of the machine 100 along with the required stopping distance ‘RD’ as well as the current speed ‘S’, as calculated in order to provide more accurate warning to the operator and thus increase the safety of the machine 100. The control system 200 of the present disclosure also subtracts the safety margin distance ‘SD’ to enhance the safety of the machine 100. The controller 210 may further prepone the alert in order to compensate for delay in operating the braking system and factor in the operator reaction time to further enhance the safety of the machine 100.

The control system 200 disclosed herein is a cost effective and easy to implement solution to warn the operator of the machine 100 in due time about a possible collision with the object ‘X’ present along the travel path 102 of the machine 100. This way the operator may be able to take necessary actions, such as applying brakes or steering away from the object ‘X’ to avoid collision with the object ‘X’. The control system 200 of the present disclosure may be easily retrofitted on existing machines without significantly affecting the hardware of the machine 100. The control system 200 provides enhanced safety for the machines 100 and the operator who is operating the machine 100.

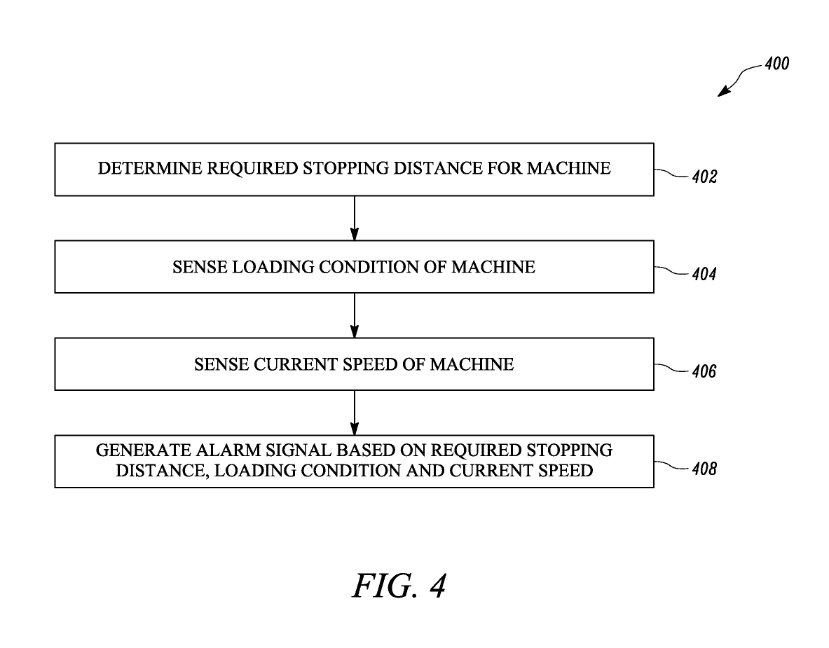

FIG. 4 is a flowchart for a method 400 illustrating the steps for operating the machine 100 as per the present disclosure. In block 402, the method 400 includes determining the required stopping distance ‘RD’ for the machine 100. In block 404, the method 400 includes sensing the loading condition ‘L’ of the machine 100. In block 406, the method 400 also includes sensing the current speed ‘S’ of the machine 100. Finally, in block 408, the method 400 includes generating the warning signal to warn an operator of the machine 100 based on the required stopping distance ‘RD’, the loading condition ‘L’ and the current speed ‘S’.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of operating a machine, the method comprising:
determining a required stopping distance for the machine;
sensing a loading condition of the machine;
sensing a current speed of the machine; and
generating a warning signal to warn an operator of the machine based on the required stopping distance, the loading condition and the current speed.

2. The method of claim 1, wherein the warning signal is generated based on pre-defined lookup maps, the lookup maps comprising values for a plurality of machine stopping distances for a plurality of combinations of the loading conditions and the current speeds of the machine.

3. The method of claim 2, wherein the warning signal is generated when the required stopping distance corresponding to the loading condition and the current speed of the machine, is substantially equal to the corresponding machine stopping distance in the lookup maps for the loading condition and the current speed of the machine.

4. The method of claim 1 further comprising, detecting an object in a travel path of the machine and determining a distance between the machine and the object, wherein the required stopping distance is determined based on the distance between the machine and the object.

5. The method of claim 4, wherein the required stopping distance is determined by subtracting a safety margin distance from the distance between the machine and the object.

6. The method of claim 1, wherein the warning signal is generated after factoring an operator reaction time.

7. The method of claim 1 further comprising, generating a warning alert based on the warning signal, wherein the warning alert is an audible alert.

8. The method of claim 1 further comprising, generating a warning alert based on the warning signal, wherein the warning alert is one or a combination of an audible alert, a visual alert, and a tactile feedback alert.

9. A control system for operating a machine, comprising:
an object detection unit configured to detect an object in a travel path of the machine, the object detection unit further configured to determine a distance between the machine and the object;
a payload sensing unit configured to sense a loading condition of the machine;
a speed sensing unit configured to sense a current speed of the machine; and
a controller configured to:
determine a required stopping distance for the machine based on the distance between the machine and the object; and
generate a warning signal to warn an operator of the machine based on the required stopping distance, the loading condition and the current speed.

10. The control system of claim 9, wherein the controller is configured to generate the warning signal based on pre-defined lookup maps, the lookup maps comprising values for a plurality of machine stopping distances for a plurality of combinations of the loading conditions and the current speeds of the machine.

11. The control system of claim 10, wherein the controller is configured to generate the warning signal when the required stopping distance corresponding to the loading condition and the current speed of the machine, is substantially equal to the corresponding machine stopping distance in the lookup maps for the loading condition and the current speed of the machine.

12. The control system of claim 9, wherein the controller is configured to determine the required stopping distance by subtracting a safety margin distance from the distance between the machine and the object.

13. The control system of claim 9, wherein the controller is further configured to generate the warning signal after factoring an operator reaction time.

14. The control system of claim 9 further comprising, an alarm device configured to generate a warning alert based on the warning signal, wherein the warning alert is one or a combination of an audible alert, a visual alert, and a tactile feedback alert.

15. A machine, comprising:
a power source configured to move the machine;
a loading structure configured to hold a payload in the machine; and
a control system for operating the machine, comprising:
an object detection unit configured to detect an object in a travel path of the machine, the object detection unit further configured to determine a distance between the machine and the object;
a payload sensing unit configured to sense a loading condition of the loading structure;
a speed sensing unit configured to sense a current speed of the machine; and
a controller configured to:
determine a required stopping distance for the machine based on the distance between the machine and the object; and
generating a warning signal to warn an operator of the machine based on the required stopping distance, the loading condition and the current speed.

16. The machine of claim 15, wherein the controller is configured to generate the warning signal based on pre-defined lookup maps, the lookup maps comprising values for a plurality of machine stopping distances for a plurality of combinations of the loading conditions and the current speeds of the machine.

17. The machine of claim 16, wherein the controller is configured to generate the warning signal when the required stopping distance corresponding to the loading condition and the current speed of the machine, is substantially equal to the corresponding machine stopping distance in the lookup maps for the loading condition and the current speed of the machine.

18. The machine of claim 15, wherein the controller is configured to determine the required stopping distance by subtracting a safety margin distance from the distance between the machine and the object.

19. The machine of claim 15, wherein the controller is configured to generate the warning signal after factoring an operator reaction time.

20. The machine of claim 15 further comprising, an alarm device configured to generate a warning alert based on the warning signal, wherein the warning alert is one or a combination of an audible alert, a visual alert, and a tactile feedback alert.
